(19) United States
(12) Patent Application Publication
(10) Pub. No.: US 2012/0168986 A1
(43) Pub. Date: Jul. 5, 2012

(54) Rigid Semi-Flexible Polyurethane for Structural Applications

(76) Inventors: Kenneth J. Warnshuis, Adrian, MI (US); Felipe R. Terrones, Adrian, MI (US); Daniel M. Morris, Adrian, MI (US)

(21) Appl. No.: 12/980,407

(22) Filed: Dec. 29, 2010

(51) Int. Cl. B29C 45/00; C08K 3/34; C08K 5/06; B28B 1/087; C08K 3/10; C08J 9/08; C08J 9/34; C08K 5/54; C08L 75/04; C08K 5/02

(52) U.S. Cl. 264/328.1; 521/170; 521/91; 521/88; 521/98; 521/92; 521/97; 521/51; 521/86; 521/81; 425/175

(57) ABSTRACT

Disclosed is a blown rigid semi-flexible urethane material that is loaded by using a wide variety of filler materials which become encapsulated in the urethane matrix. Disclosed are sample formulation and material variations, possible products that can be manufactured from the material, and possible material processing options and methods of manufacturing the material. Disclosed are possible methods of molding the material including a new cost effective method of molding variations of many interior and exterior products.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### NAMES OF THE PARTIES TO A JOINT RESEARCHING AGREEMENT

“Not Applicable”

### INCORPORATION-BY-REFERENCE OF MATERIAL SUBMITTED ON A COMPACT DISC

“Not Applicable”

### BACKGROUND OF THE INVENTION

On Feb. 22, 2008, a problem was encountered during the routine molding of decorative souvenirs using an epoxy resin with alabaster as a filler material. The resin and alabaster, after mixing, was foaming, causing the volume of the material to expand and subsequently ruining the souvenirs. After some initial investigations and trials, moisture in the alabaster was theorized to be the problem. As a solution, the alabaster powder was dried in an oven for 20 minutes at 300 degrees F. The resulting subsequent production showed that the drying corrected the problem with the mixture and the foaming was eliminated. The foamed material, while being a rigid material, had a core matrix similar to flexible polyurethane foam. The core was stiffer than normal flexible polyurethane but still maintained some flexibility which was unusual. The information was committed to memory.

In October of 2009, discussions were had about the manufacturing of siding shingles using the resulting formulation from the trials detailed above. As a result, a molded open pour process was proposed for the production of the shingles. The following beginning formulation was proposed with a water content based on the February 2008 observations.

### EXAMPLE 1

Initial formulation for the development of an in mold painted siding shingle for exterior cladding for use in residential and non-residential application consisting of the following:

| | |
|---|---|
| Isocyanate | 30.3% |
| Polyol | 30.3% |
| Load | 30.3% |
| Flame-retardant | 9.1% |
| Blowing agent plus catalyst | 0.1% |

A cost analysis was completed based on these initial trials. No parts were made or any other experimentation completed due to lack of funds.

As a result of these successful first trials, the molded siding shingle concept was conceived and a cost analysis showed promise for this process of manufacturing. At the same time in mold painting of the shingles was discussed, as were various process and equipment issues. The art of in mold painting flexible, rigid, and semi-flexible urethane products is an important part of the cost effectiveness of this initial design concept. Knowledge in this field stems from prior experience in producing molded flexible polyurethane foam for the automotive and seating industries using high speed turntables and in mold painting.

Around the first of November, the team pooled their money and had a shingle mold made. Chemicals and process equipment were obtained for the purpose of running sample parts.

### EXAMPLE 2

On Nov. 11, 2009, the process of running test parts began. The following formulation was used:

| | |
|---|---|
| Isocyanate | 38.5% |
| Polyol | 38.5% |
| Load | 22.7% |
| Blowing agent plus catalyst | 0.3% |

Good parts were obtained after a day of experimentation. Parts were run using different formulations during the first two weeks in November using various filler materials, water parts, catalyst, and process parameters. During this period the idea of an insert for the mold was discussed. The insert system would allow the use of one mold with the ability to vary the pattern, grain, reveal, and thickness of the siding shingle. At the same time, many other products were discussed and the insert system would work on these products also. The initial prototype mold was modified on design to accommodate this insert feature.

### EXAMPLE 3

On Nov. 19, 2009, parts were run using the modified mold and insert concept. The following formulation was run.

| | |
|---|---|
| Isocyanate | 24.9% |
| Polyol | 24.9% |
| Load | 49.8% |
| Blowing agent plus catalyst | 0.4% |

On Nov. 30, 2009, good parts were produced and the insert concept worked. At this time parts were made using the in mold paint concept. A few days of trials involving different paint and mold release combinations were tried. On Dec. 14, 2009 one combination worked well, producing a paint that bonded to the shingle substrate. The bond between the paint and shingle was excellent, passing the cross hatch test with no paint pull-up. Good parts were run in December with various filler materials trialed. The results showed that most filler material will work but that some are not cost effective.

### EXAMPLE 4

Continued trials resulted in several variations of the current formulation with the best results coming from the formulation utilized on Sep. 18, 2010. The formulation consisted of the following:

| | |
|---|---|
| Isocyanate | 36.8% |
| Polyol | 47.3% |
| Load | 15.8% |
| Blowing agent plus catalyst | 0.1% |

Information on experiments, cost analysis, and other details are saved as hard copies.

### Table 1

Testing of the in-mold coating over foam substrate for humidity, freeze thaw, adhesion, boiling water, and heat buildup was conducted with samples produced with the formulation detailed in example 4 above. All tests were conducted as planned with the exception of the heat buildup test. With the foam core, the heat will not penetrate the substrate enough to get a good reading from the bottom. Instead an infrared gun was utilized to read the surface heat and the resulting measurements were used as a guide. Though different than the standard procedure it should not change the results.

| | | |
|---|---|---|
| Adhesion: | 5B | 0% Loss |
| Boiling Water: | 5B | 0% Loss |

| | |
|---|---|
| Humidity: | No blisters or cracking at 300 hr. |
| Freeze Thaw: | No cracking after 20 cycles. |
| Heat Buildup: | HBU - 56 |

In conclusion, all tests were performed on the foam substrate as indicated, with very good results on all testing. The adhesion with a 5B showed no loss of coating in standard adhesion test and Boiling Water Adhesion test. The Freeze Thaw test showed no cracking or separation of any kind after 20 cycles. Humidity test for 300 hours detected no change in the coating at all. The Heat Buildup, although adjusted for the insulation properties of the foam, indicated a very small temperature change on the surface of the material. This is in step with a lighter colored material as supplied and it is not expected that any warpage should result with most dark colors on this substrate.

### Table 2

In addition to the above mentioned tests conducted by an outside laboratory, internal tests have been conducted that reflect the following results on a painted substrate in line with the examples one thru four detailed above.

| | |
|---|---|
| Water absorption: | less than .5% |
| Thermal stability: | 180+ deg. |
| Burn Test: | self extinguishing |
| | (two minute exposure to flame source) |
| Silicosis test: | negative |
| Mold and termite resistant: | Pass |
| MEK rub test: | No appreciable change |
| Cross hatch: | Pass |

### (1) FIELD OF THE INVENTION

As detailed by Chittolini in U.S. Pat. No. 5,859,078, Polyurethane is well known as a base product for the manufacture of rigid, flexible, and semi flexible foams. Polyurethane foam is produced by the intimate mixing of an isocyanate component and a polyol component which contains all or some of the following homogeneous mixtures:
Polyols—reactive products of suitable molecular weight for reacting with the isocyanate to foam a rigid, flexible or semi flexible product;
Catalyst—generally tertiary amines or potassium, tin or lead slats, which regulate the reaction rate;
Surfactants—which affect the surface tension and regulate the formation of the foam;
Water—this reacts with the isocyanate to produce carbon dioxide which acts as an expander;
Flame-retardants—which regulate the behavior of the foam with respect to fire;
Expanding agents, that is, low-blowing products—which regulate the expansion of the foam;
Additives—such as fillers, dyes and pigments for various applications

The polyol component and the isocyanate component are thermostatically controlled, metered, mixed and poured by means of suitable machines. Various formulations of the polyol component are used to produce different types of rigid, flexible, or semi-flexible foams by various processes including but not limited to;
Continuous and discontinuous production of rigid or flexible foam blocks;
Continuous or discontinuous production of rigid foam panels; poured and/or sprayed rigid foams;
Mould casted high-density rigid foams with integral skins;
Mould casted low density flexible or semi-flexible cold molded foam;
And molded semi-expanded and unexpanded mould casted foam.

Polyurethane is well known as a base product for the manufacture of a wide variety of products including cushions, mattresses, seat padding, arm-rests, bumpers, insulation in refrigerators and freezers, insulating panels for building, insulating for pipes and tanks, as well as high-density rigid foams for furniture.

### (2) DESCRIPTION OF RELATED ART

Polyurethanes and urethanes are very much in the public domain. Flexible, rigid, and semi-flexible are a few variations of the base polyurethane formulation. The present invention varies from other common polyurethane systems as detailed in U.S. Pat. No. 5,859,078 in that no solvent blowing agents are required. The urethanes and/or silicates require moisture to cure and expand, with the addition of fillers that enhance the expansion effect.

Composite materials detailed in U.S. Pat. No. 7,037,865 use urethanes and high filler load plus reinforcing materials to create composites. The present invention improves upon and solves problems with this patent as detailed by the following;
[1] The composites in U.S. Pat. No. 7,037,865 absorb and retain water. The ratio of resin to load is high allowing water to be absorbed as a result of the fillers (load) not being encapsulated. The present invention provides for an adequate ratio for the urethane to properly encapsulate the fillers.
[2] Using reinforcing materials creates vehicles by which wicking occurs, allowing water intrusion into the product. The present invention provides strength without the use of reinforcing materials.
[3] The material strength is suspect due to high load to resin ratio. The current invention uses urethane as the basis for material strength.
[4] The composite materials have heat related problems which cause a low melting point. The current invention's melting point can be varied by adjusting the chemical components of the formulation to a minimum melting point of 180°+(f).
[5] Processing of composite materials in U.S. Pat. No. 7,037,865 is very difficult. In the present invention, handling and forming material is easily achieved, repeatable, and can be adapted to various processes to create a wide variety of products.
   [6] The composite material patent focuses on the use of microspheres as filler. The present patent uses a wide variety of fillers with the same result.

### BRIEF SUMMARY OF THE INVENTION

The invention pertains to a series of formulations for and a variety of method for producing foamed materials with rigid characteristics consisting of a core matrix similar to flexible polyurethane foam. The core, which is stiffer than normal flexible polyurethane still maintains some flexibility.

### DESCRIPTION OF DRAWINGS

“Not Applicable”

### DETAILED DESCRIPTION OF INVENTION

The invention detailed in the claim below is suitable for use in any of the following list of products for interior or exterior application such as, but not limited to, roof shingles, siding shingles, siding boards, trim, moldings, garage doors, ceiling panels, fence boards, stone, and brick panels. In addition, the material formulations detailed can be used to repair existing poured basement walls, cement block walls, columns, and various other structural components making these impervious to water intrusion. Additional details of the preferred embodiments of the invention are discussed in the latter part of the Claims.

1. We claim the benefits of U.S. Provisional Patent Application No. 61/292,135, RIGID SEMI-FLEXIBLE POLYURETHANE FOR STRUCTURAL APPLICATIONS, filed on Jan. 4, 2010, by Kenneth Warnshuis, which include all of the following updated claims.
(a) Cross-linked organic polymer material comprised of a mixture of some or all of the following components: isocyanate, polyol, flame-retardant, catalyst, blowing agent, and loaded materials ranging from 10 to 50 percent by weight which become encapsulated in a urethane matrix.
(b) Loaded materials in claim (a) can be, but is not limited to solid microspheres, hollow microspheres, fly ash, or amorphous materials such as perlite.
(c) Loaded materials in claim (a) can be, but are not limited to synthetic microspheres or any other man-made particulate materials such as, but not limited to polyvinyl chloride and decabromodiphenyl oxide, or chemical and amorphous silicates.
(d) Loaded materials in claim (a) can be inorganic materials such as, but not limited to calcium carbonate, barium sulfate, aluminum trihydrate, perlite, antimony trioxide, zinc oxide, zinc borate, talc, magnesium hydroxides, zinc stannates, and cement.
(e) Loaded materials in claim (a) can be blends of materials in claims (b) thru (d).
(f) Urethane material in claim (a) may be foamed or blown using materials such as, but not limited to 245FA, freon, methylene chloride, ethylene glycol, water, or carbon dioxide (liquid or solid).
(g) Urethane material in claim (a) is any material capable of producing a rigid matrix such as, but not limited to epoxy, polyether polyol, polyester polyol, polypropylene, polyethylene, polyurethane, urethane or any other suitable organic polymer, also any biomass polymers from but not limited to soy, switchgrass, corn, etc.
(h) Material in claim (a) and (g) may form a skin on the surface as part of the chemical matrix.
(i) The isocyanate component of the urethane in claims (a), (g), and (h) may be, but is not limited to Diphenylmethane diisocyanate (MDI), Toluene diisocyanate (TDI), or any blends of isocyanates and blends of isocyanates and polysilicate binders.
(j) The density of the material produced in claims (a) thru (i) is from 10 pcf to 75 pcf depending upon the formulation used to produce the desired physical properties.
(k) The urethane material in claims (a), (g), and (h) may have other materials added such as, but not limited to surfactants, catalysts, crosslinkers, blowing agents, water, dyes, UV protectors, organo functional silanes, or any other materials required by the formulation for final product applications or characteristics required for the final product.
(l) Components, devices, applications or treatments such as, but not limited to primers, paints, foils, plastics, vinyls, or components such as, but not limited to sensors, fasteners or any other value added features may be molded, pressed into or applied to the surface of the material produced in claims (a) to (k).
(m) Materials produced in claims (a) to (l) may be used in, but are not limited to interior or exterior applications, including use in water structures.
Preferred Embodiments
(n) Process techniques such as, but not limited to open pour, injection molding, extrusion, compression, or free rise can be used to produce the material in claims (a) to (m).
(o) The material in claims (a) to (n) lends itself for molded applications using an open pour clam shell mold. This material is very stable and can be used to produce a wide variety of densities. Siding shingles from 10 pcf to 55 pcf have been successfully produced. Key to the process is the materials' ability to be blown and remain stable, while still producing a rigid material with flexible foam characteristics. Required material characteristics and specifications may be varied by changes in chemicals, ratios and process parameters.
(p) The material in claims (a) to (o) can be mixed and poured using a variety of wet systems such as, but not limited to extrusion, injection, and high or low pressure mix heads. Molding processes can vary according to the product produced. Molds can be open or closed pour. This material can be poured on a conveyor and compressed by a top conveyor to produce sheets of material. Additionally this material can be poured and allowed to free rise to form basement walls and columns impervious to water intrusion. This material can be used to repair existing poured basement walls, cement block walls, columns, and various other structural components making these impervious to water intrusion. These are a few examples of processing methods and possible applications but not all.
(q) The material in claims (a) to (p) can use slow to high speed production molding lines to process material in high volumes. Examples include, but are not limited to stand-up molds, turntables, race tracks, carousels, belt conveyors, and a squirrel cage type carousel.
(r) Examples of material in claims (a) thru (i) can be interior and exterior molded products such as, but not limited to roof shingles, siding shingles, siding boards up to 20 feet long, trim applications, deck materials, door panels, and imitation stone and brick panels.
(s) The molds in claims (a) to (r) can be coated with a urethane bonding material such as, but not limited to primers, paints, sealers, and others, to enhance the finished product. After coating the mold surface, the chemical blend is poured into the mold and allowed to react. After cure, the part is removed from the mold. The coating has bonded to the surface forming a superior adhesion which resists most kinds of damage. This coating is superior to normal process painted surfaces because of the enhanced chemical bond that is created during the manufacturing process.
(t) A novel mold design allows a section of the mold to accept inserts with different designs. An insert section allows inserts to be changed in the mold bowl as needed. Inserts can be produced from a variety of materials such as, but not limited to aluminum, steel, epoxy, and silicone. Using our concept, customers will be able to custom design their shingles, at a competitive price, using any of the following characteristics, but not limited to shape, design, pattern, thickness, color, or reveal.
